(19) United States
(12) Patent Application Publication
(10) Pub. No.: US 2024/0338757 A1
(43) Pub. Date: Oct. 10, 2024

(54) System and method for management of online auction

(71) Applicant: Pei Lin CHOU, Taipei (TW)

(72) Inventor: Pei Lin CHOU, Taipei (TW)

(21) Appl. No.: 18/399,799

(22) Filed: Dec. 29, 2023

(30) Foreign Application Priority Data
Apr. 7, 2023 (TW) 112113181

(51) Int. Cl. G06Q 30/08; G06Q 30/018

(52) U.S. Cl. CPC G06Q 30/08; G06Q 30/018

(57) ABSTRACT

A system for management of online auction manages multiple bidding pools. One or more buying demand for the same product/service with the same closing time forms a bidding pool. The system accepts sellers' bidding offers which compete with each other. Within a first predetermined time before the closing time of a bidding pool, buyers of selected pools are allowed to withdraw and join the closing pool. The present invention also provides a method for managing online auctions used in the invented system.

### TECHNICAL FIELD

The present invention relates to a system for management of online auction, in particular to a system for managing online reverse auctions for product/service in a group buying. The invented system provides a buying demand, especially the buying demand of a plurality of buyers, and accepts plural seller biddings to win a contract with a lower price. The present invention also discloses a method for managing online auctions used in the invented system.

### BACKGROUND OF THE INVENTION

The so-called group buying refers to the formation of a group of people who demand a specific product/service. After the demands accumulate into a certain quantity, sellers attracted by the demands would offer to sell the demanded product/service at a lower price, or a reduced price, mainly because of the accumulated transaction value and the reduced unit transaction expenses. Since group buying can improve the efficiency of online transactions, a variety of automated management systems for online group buying has been proposed.

For example, TW 201201130 discloses a “system and method for matching transactions in internet.” In order to urge the seller to further reduce the price, so to successfully match up a transaction earlier, the invention configures its offer matching device to provide an exclusive negotiation period for a predetermined time, when predetermined conditions are met, in which period the system accepts offers made by a seller of priority, only.

In order to improve the efficiency of group buying, solutions were proposed from various countries, after substantial researches and developments. Among them, U.S. Pat. No. 7,958,013B2 discloses method, system and business model for a buyer's auction with near perfect information using the internet. A nearly perfect information is obtained using a computer-implemented method, to match up a transaction between a potential buyer and a plurality of potential sellers through electronic bidding.

The method comprises the steps of: receiving an invitation to offer from a buyer; receiving offers from at least two sellers; automatically generating rating information on the sellers' offer according to predetermined criteria, including at least one criterion other than the price; after all seller offers are received, receiving adjusted offers from sellers in response to an event specified by the buyer. In this invention, the buyer can be a buyer group.

U.S. Pat. No. 8,676,664B2 discloses a system and method for enhancing buyer and seller interaction during a group-buying sale. The invention provides a method and system that enable buyers and sellers to communicate with each other during group buying opportunities and to negotiate the terms of purchase of featured items. Sellers and buyers can use various forms of online group buying mechanisms in combination with the negotiation features of this invention. Buyers can send various inquiries about the featured items to sellers. Sellers can change the sales conditions of an ongoing online group buying, such as further reducing the price. The method and system can also calculate a “flash demand curve,” according to the buyer's quotation, so as to be used in online group-buying sales.

The “flash demand curve” disclosed in the invention provides sellers and buyers with real-time data updated at intervals, representing the quantity of irrevocable or revocable buying demands that buyers have put forward for the ongoing bidding of a specific product/service, as well as the buyer's price offers. The flash demand curve differs from a traditional demand curve in that a flash demand curve does not necessarily include irrevocable offers. The inventors believe that the shorter time interval of the flash demand curve can provide sellers with sufficient information on the actual demand of the online group buyers before a contract is closed, so that sellers can provide a reduced price or a gift at any time according to the demand, so to win a contract.

U.S. Pat. No. 6,631,356B1 discloses a method for demand aggregation through online buying groups, which forms an online buying group and defines its conditions such as group buy start time, closing time, threshold quantity, minimum quantity per order, maximum purchase quantity, initial price, and product cost curve. After the system corrects the initial price according to the market price, it releases the information of this buying group, whereby sellers may be attracted and offer selling conditions to the system. The released information includes: current price, closing time, and next-level price. The buyer can agree to the price, only if the buyer's purchase quantity reaches a threshold. The buyer can also provide a reduced counter-offer, only if the current price of the group buy falls to the price. At the closing time, if the purchase quantity reaches the threshold quantity, or the current price of the group buy drops to the reduced price, a contract is closed. The system then enters the steps of payment collection and shipment.

U.S. Pat. No. 6,199,050B1 discloses a method and system for bidding in electronic auctions using flexible bidder-determined line-item guidelines. When the closing time of a previous bidding pool is extended by the system, whereby it becomes too close to the closing time of the immediately following bidding pool, the system will dynamically extend the closing time of the subsequent bidding pool, to avoid collision in the closing time of multiple bidding pools. The invention provides a dynamic management method for multi-pool auctions.

US20130018746A1 discloses a buyer group definition for a demand driven promotion system. A method for organizing group buying comprises: providing a buyer group definition interface for the buyer to input the following information relating to a buying demand: identification of product, closing time, buyer group size, seller identification, and date, shipping address, and geographic information relating to the buyer group. The closing time of the transaction mainly refers to the lifetime of the group buying or the time when it will cease to exist. The buyer groups may only exist during a single purchase. The system may include a deadline and/or maximum period set by the system or by the buyer.

From the above description of the prior art, it can be seen that group buying can effectively prompt sellers to propose prices that are attractive for buyers to accept. The industry has proposed a variety of modifications and improvements for the online system of group buying from different points of view.

### OBJECTIVES OF THE INVENTION

The objective of the present invention is to provide an improved system and method for management of online group-buy auctions for product/service, which can be applied, when multiple bidding pools of group buying are formed for the same product/service, so as to urge buyers and sellers to win a contract with the optimal conditions.

Another objective of the present invention is to provide a novel online auction system that can break the boundary between bidding pools in the traditional multi-pool group buying auction system.

According to the present invention, the system for management of online auction provides buying demands, especially the buying demands of plural buyers, for one product/service and accepts offers from plural sellers.

The present invention also provides a platform where multiple bidding pools for the same product/service can be organized and processed at the same time and they can compete with each other. The invented system is configured to allow potential buyers who are in participation in other bidding pools to join a closing bidding pool within a predetermined time before the closing time of the closing bidding pool, so as to encourage potential sellers who have or have not provided their biding offer to provide more favorable biding offers. In a specific embodiment of the present invention, within the predetermined time, buyers who join the closing bidding pool are allowed to withdraw from the bidding pools that offers the same product/service and in which they are participating.

The present invention provides a system for management of online auction, which transmits and processes auction information in a computer network capable of communicating between a host computer and a plurality of remote client computers. The system comprises:
a host computer having data processing and communication capabilities, connected to the computer network, and configured to transmit data to and receive data from the remote client computers via the computer network;
a product database in communication with the host computer, configured to store product information, wherein the product information describes identifications of product/service available for bidding transaction, and an index to a plurality of qualitied sellers corresponding to each product/service; wherein in the product database, the product information of the products/services available for bidding transactions comprises a product classification code, whereby a plurality of products/services corresponding to a same classification code is classified as a same product or alternative products;
a seller database in communication with the host computer, configured to store seller information relating to a plurality of qualified sellers; wherein the seller information further comprises descriptions relating to payment instruments usable by a corresponding seller and products/services relating to a corresponding seller;
a buyer database in communication with the host computer, configured to store buyer information of a plurality of qualified buyers, wherein the buyer information may further comprise descriptions relating to a credit limit of a corresponding buyer and payment instruments usable by a corresponding buyer;
an auction database in communication with the host computer, configured to store buying demand information and bidding offer information, wherein the buying demand information describes buying demands of products/services received from one of the remote client computers, and may further comprise product information, demanding quantity and expected closing time of a corresponding product/service; and wherein the bidding offer information describes bidding offers of products/services received from one of the remote client computers, and may further comprise product information, offering price and expected closing time of a corresponding product/service; wherein a time gap between closing times of two bidding pools of a same product/service is an integral multiple of a standard time gap; and
an auction management device, implemented in the server computer and in communication with the product database, the seller database, the buyer database and the auction database, configured to receive and to process buying demand information and bidding offer information of products/services received by the auction database, and to determine whether a contract consisted of a buying demand and a bidding offer is concluded;
wherein the auction management device is configured to manage multiple bidding pools for product/service, wherein one or more buying demand for a same product/service with the same expected closing time forms a bidding pool;
wherein the auction management device provides an auction webpage for one of the remote client computers to access through the computer network; wherein the auction webpage displays at least descriptive information of at least one bidding pool which closing time is not up;
wherein the auction management device is configured to set a closing time for a product/service in the product database, and to cause a buying demand of product/service to include only one expected closing time, and to include all buying demands for a same product/service with a same expected closing time into one bidding pool;
and wherein the auction management device is also configured to allow a buyer having placed a buying demand in one of selected bidding pools to withdraw the buying demand from the participating bidding pool within a first predetermined time before a closing time of another bidding pool.

In a preferred embodiment of the present invention, the auction management device is configured to allow a buying demand in one of selected bidding pools to withdraw from the participating bidding pool within the first predetermined time before the closing time of the other bidding pool, if the time difference of the closing times of the selected bidding pools and the other bidding pool is less than a second predetermined time.

In some other preferred embodiments of the present invention, the auction management device is configured to allow a buying demand in one of a predetermined number of bidding pools, which closing time is after a closing time of another bidding pool, to withdraw from the participating bidding pool, if a corresponding buying demand by the same buyer is placed in the other bidding pool.

In most embodiments of the present invention, the auction management device is configured to place a buying demand of a buyer in a predetermined bidding pool, when the buyer withdraws a buying demand from a participating bidding pool. The predetermined bidding pool may be a bidding pool with an earliest available closing time or a bidding pool selected by the buyer.

In most embodiments of the present invention, the auction management device may be configured to withdraw a lowest bidding offer of a bidding pool, when a quantity of the buying demands of the bidding pool is less than a quantity of buying demands at the time the lowest bidding offer is placed, and replace the lowest bidding offer with a second lowest available bidding offer. In such embodiments, the bidding managing tool may also be configured to, before withdrawing the lowest bidding offer, obtain a determination of whether to withdraw from the seller with the lowest bidding offer, and to stop withdrawing the lowest bidding offer, if the determination is not to. The auction management device may also be configured to, when accepting a bidding offer, obtain a minimum quantity requirement to the bidding offer and to withdraw the bidding offer, when the buying quantity of the corresponding buying demands is less than the minimum quantity, or, in addition, to replace the bidding offer with a second lowest available bidding offer.

In other embodiments of the present invention, within the first predetermined time, potential sellers may also be allowed to place a conditional bidding offer, wherein the condition may comprise a minimum quantity.

The auction management device may be configured to close a bidding pool at the closing time of the bidding pool and use the lowest bidding offer at the closing time as a concluded price of the bidding pool.

In a preferred embodiment of the present invention, the auction management device is configured to:
when receiving a buying demand for a product/service, determine whether a bidding pool for the same product/service with a closing time identical to an expected closing time of the buying demand is included in the auction database;
if yes, include the buying demand to the bidding pool and update a bidding offer information of the bidding pool;
otherwise, determine whether a bidding pool for the same product/service with a closing time different from the expected closing time of the buying demand by a time shorter than the standard time gap is included in the auction database;
if yes, include the buying demand to the bidding pool and update a bidding offer information of the bidding pool;
otherwise, establish a new bidding pool in the auction database and include the buying demand to the newly established bidding pool, followed by setting a closing time of the newly established bidding pool as a time different from a closing time of an immediately preceding bidding pool by an integral multiple of the standard time gap. In the preferred embodiments of the present invention, the founding buying demand may include a maximum price limit, to limit maximum price for bidding offers of the bidding pool; whereby a bidding pool is formed.

In a preferred embodiment of the present invention, the auction management device can also comprise a demand and bid validator and an notification manager; wherein, the demand and bid validator can be implemented in the host computer for verifying information from the client computer to determine whether a buying demand and/or a bidding offer is valid; and
the notification manager is in communication with the host computer, the auction management device and the auction database, for providing electronic notification to the remote client computer via the host computer.

The invented management system may also comprise a fee collecting device, configured to notify buyers and corresponding winning sellers of the winning price and quantity after a bidding pool is closed, so as to complete the transaction.

In a preferred embodiment of the present invention, the auction webpage can additionally display descriptive information of at least one bidding pool whose closing time has passed. The auction web page may also display descriptive information of multiple bidding pools that have not yet reached the closing time. The descriptive information of the multiple bidding pool may be arranged in sequence according to the closing time.

A form of the descriptive information of the bidding pools may comprise the following fields: description of product/service, closing time, minimum quantity requirement, and current most-favorable bidding condition. It may also comprise information regarding standard difference in bidding conditions, such as standard price differences.

Said bidding condition may be unit price of a related product/service; the most-favorable bidding condition would in most case be a lowest bidding price. Said bidding condition may also be a unit price of the product/service and its premise conditions; a premise condition may be a minimum quantity requirement of buying demands of the corresponding product/service.

When using the invented system, buyers and sellers can view the auction information of all the ongoing bidding pools and the closed bidding pools from the auction webpage, and search for interested products/services. Buyers can participate in any ongoing bidding pool or establish a new bidding pool. The auction webpage is accessible by the public via the Internet, attracting buyers to place buying demands for any available product/service on the Internet. On the other hand, sellers can check for interested products/services in the auction webpage, and bid with favorable bidding conditions, such as a lower selling price, to replace the most-favorable bidding offer at that time. When the bidding conditions of a bidding pool are much favorable than those of other bidding pools for the same product/service, buyers of the other pools can choose to withdraw from the other bidding pools and participate in the bidding pool that offers more favorable conditions. Sellers who find that the quantity of buying demands for this bidding pool has increased can also participate in bidding pool to win the contract. At the closing time of the more favorable bidding pool, the auction management device determines a transaction is concluded, and notifies the buyers and the winning seller with an electronic message.

The present invention provides a novel group buy, auction system and method, so that both buyers and sellers can achieve the most favorable transaction conditions.

Other objectives and advantages of this invention may be clearly appreciated from the detailed descriptions, by referring to the following figures.

### BRIEF DESCRIPTION OF THE DRAWINGS

FIG. 1 shows the system schematic diagram of the system for management of online auction of the present invention.

FIG. 2 shows a flow chart of a method for forming a bidding pool applicable to the system for management of online auction of the present invention.

FIG. 3 shows a flowchart of the method for managing an auction transaction applicable to the present invention.

### DETAILED DESCRIPTION OF THE INVENTION

The following embodiments illustrate the main structure, examples and various possible implementations of the system and method for management of online auction of the present invention. However, the description of the embodiments is for the purpose of illustrating the possible applications of the invention, and for the reader to understand the invention. The scope of protection of the present invention is not limited to the examples described below.

The present invention provides a system and method that overturn the conventional auction mechanism. The implementation of the present invention basically follows the existing online group buying and auction process, but the methodology is completely different. In the invented system and method, not only sellers compete with each other, with such as price competition as in the conventional group-buying mechanism, but also the bidding pools compete with each other, for example, competing by their demand quantity. The invention can achieve the objectives of attracting more buyers to join group buying and attracting sellers to place the most favorable conditions.

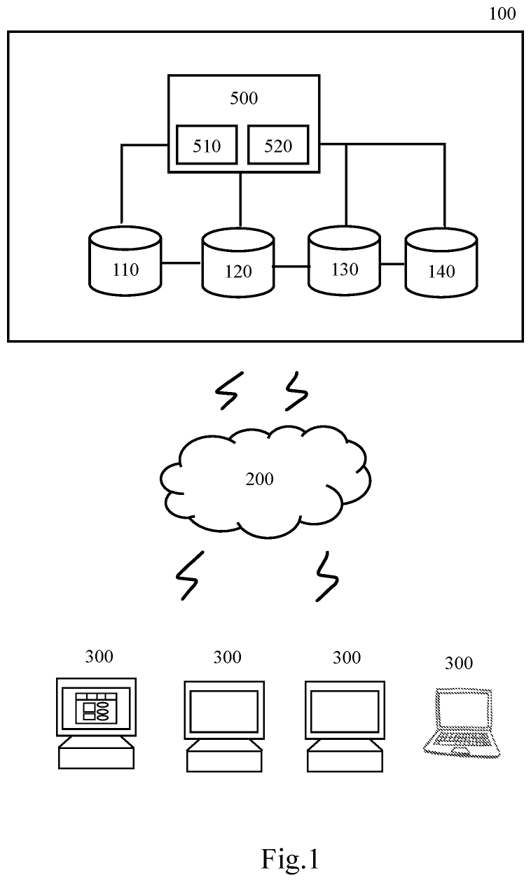

FIG. 1 shows a systematic diagram of the system for management of online auction of the present invention. As shown in the figure, the invented system for management of online auction is mainly implemented in a host computer 100, and provides services in the form of product/service auction management system or the like. The host computer 100 is preferably a server-level computer, and can communicate with a plurality of remote client computers 300 through the Internet or other forms of computer networks 200 to transmit and process auction related information.

The figure shows that an implementation of the system of the present invention may include a host computer 100, and product database 110, seller database 120, buyer database 130. auction database 140, auction management device 500 etc., which can be built in the host computer 100 or in other computer equipment.

In the system, the host computer 100 has data processing and communication functions and capabilities, and is connected to the computer network 200. The host computer 100 can transmit data to and receive data from the remote client computers 300 via the computer network 200.

The product database 110 is in communicative connection with the host computer 100. The product database 110 can utilize the powerful computing and data storage capability of the host computer 100, to store a large amount of product information that relates to products/services available for purchase. In the description below, the term “product” would usually mean products and services, unless otherwise specified. The product information describes the products/services available for purchase, including product names, brand names, model name/number, or other descriptive expressions or symbols. It can also include photos or animation. These and other descriptions and representations are referred to as “identification of product/service” below. The product information may also include a list of indices pointing to qualified sellers for each product/service, in the seller database 120, and the products/services they sell.

In the product database 110, the product information of the products/services that are available for purchase includes a classification code. In a preferred embodiment of the present invention, all products/services with the same classification code are grouped as the “same” product/service. Therefore, although different names, codes or other representations are used to describe, products/services having the same product code can be identified by the auction management device 500 to facilitate correct processing.

However, in some embodiments of the present invention, the product/service classification code may also be assigned to a plurality of products/services alternative each other, so that the group of alternative products/services are treated as the same product/service by the invented system. This classification method helps to further improve the efficiency of the inter pool competition mechanism created by the present invention.

The purpose of grouping multiple products/services as one same product/service is mainly to enable the group-buying and bidding transaction system of this invention to identify mutually replaceable products/services, so as to enhance the competition among bidding pools. According to the design of the present invention, when the closing time for a bidding pool is approaching, the system allows buyers of other bidding pools for alternative product/service to withdraw from their bidding pools and participate in the closing bidding pool. At this time, the system must correctly determine which bidding pools are providing alternative items, so that their buying demands can be transferred to the closing bidding pool. Here, the term alternative products/services refers to two or more products/services with similar specifications, functions and prices, or two brands or models of the same product/service, and they can generally replace each other. Of course, the specific rules of classification can be determined by the system administrator during actual operations. The seller database 120 can provide an input interface for the system administrator, for changing the classification codes in the identification information of the related products/services.

The seller database 120 is in communicative connection with the host computer 100 and is configured to store descriptive information of a plurality of qualified/verified sellers. The stored seller information may include descriptive information of payment instrument used by the seller, such as bank account number, electronic payment account, and the like. In addition, the buyer database 130 is also in communicative connection with the host computer 100 and is configured to store descriptive information of a plurality of qualified buyers. Here, the term “buyer” refers to an individual or organization that has been verified and accepted and has the right to initiate or participate in a group buying, that is, a bidding pool. The buyer information may include descriptive information for credit limit and payment instrument corresponding to specific buyers. Like any auction website or bidding transaction website, the system for management of online auction of the present invention preferably only allows qualified sellers to submit bidding offers to sell products and services. Also only qualified buyers are allowed to initiate or participate in a bidding pool to buy products/services.

The auction database 140 is also in communicative connection with the host computer 100, and is configured to store the information for a large amount of buying demands and bidding offers for products and services available in the product database 110. According to the embodiments of the present invention, the buying demand information describes the buying demands for product/service, as received from one of the remote client computers, and may comprise descriptive information of demanded product, quantity of product, expected closing time and other useful information. The bidding offer information describes bidding offers received from one of the remote client computers. The bidding offer information may comprise identification information of the products/services available to sell, expected selling price, and the closing time of the bidding pool to which this bidding offer is placed. In the embodiments of the present invention, the buying demands and the bidding offers that denote to the same product/service and have the same expected closing time are grouped into a bidding pool. It can also be called a group buying, although most members of the buyer group may not have any connection with another member. In a group buying, the bidding offer with the most favorable bidding conditions is the active or effective bidding offer at the time, which is preferably the offer with the lowest price.

The auction management device 500 can be an independent computer device, but can also be implemented in the host computer 100. The auction management device 500 is in communication with the product database 110, the seller database 120, the buyer database 130, and the auction database 140, and is configured to receive and process the buying demands and the bidding offers of the then available products/services, as they are received by the auction database 140. Another important function of the auction management device 500 is to determine a transaction consisted of a plurality of buying demands and a bidding offer is concluded, when the conditions for concluding a transaction are met. In a preferred embodiment of the present invention, the condition for concluding an auction is usually the existence of an active bidding offer at the closing time of a bidding pool, whereby the bidding condition would be the price of the active bidding offer at the closing time. That is to say, the buyers who participate in the bidding pool at that closing time are the buyer, the products/services corresponding to the bidding pool are the objective of sale, the one who placed the bidding offer that is active at the closing time is the seller, and the price corresponding to the active bidding offer at the closing time is the sales price, all of the concluded sales contract.

The auction management device 500 may also include a demand and bid validator 510 and an notification manager 520. In them, the demand and bid verifier 510 can also be implemented in the host computer 100, and is configured to verify the buying demands and the bidding offers received from the remote client computer 300, so as to determine whether the demands and/or the offers are valid. The notification manager 520 is in communication with the host computer 100, the auction management device 500 and the auction database 140, for providing electronic notification to the remote client computers 300 via the host computer 100.

A system for management of online auction having the above-mentioned product database 110, seller database 120, buyer database 130, auction database 140, and auction management device 500 can be available in the market. There are many online price competition systems that can provide the above functions in all countries in the world, including auction management systems and group buying management systems. Relevant technical details can thus be omitted here. The foregoing prior art documents also provide fairly detailed descriptions, for the readers' reference.

The auction mechanism of the system for management of online auction of the present invention is basically the same as that of the existing online auction system. However, the management schematics of the present invention is completely different from the known technology and will be described in detail below.

Although the present invention does not need to be limited by any theory or principle, one feature of the present invention is that for the same product/service, or for a group of alternative products/services, a plurality of bidding pools with different closing time can be founded, in which the time difference of two consecutive bidding pools is set to a standard game gap or an integral plurality of the standard time. Under this arrangement, there may be multiple bidding pools for the same product/service, or for a group of alternative products/services, which are distributed along the time axis with a certain time distance from each other.

In addition, same as the existing online auction system, the auction management device 500 provides an auction webpage for one of the remote client computers 300 to access via the computer network 200. However, a special feature of this invention is that, in addition to displaying the descriptive information of a bidding pool selected by the client computer 300, the auction web page also displays descriptive information of at least one bidding pool whose closing time has not yet been reached. As is well known, the information displayed on the auction webpage would generally include descriptive information of the above-mentioned bidding pools, that is, at least including description of the product/service, current demand quantity, active bidding offer and other necessary or useful information. In a preferred embodiment of the present invention, the auction webpage preferably displays multiple bidding pools that are about to closed and, preferably, bidding pools that have already been closed in addition.

According to a preferred embodiment of the present invention, the auction management device 500 is preferably configured to set a closing time for any product/service in the product database 110, and have the remote client computers 300 to include the information of only one expected closing time in all the buying demands they place. The auction management device 500 groups the multiple buying demands for the same product/service with the same expected closing time into a bidding pool.

In order to achieve this goal, an embodiment of the present invention forms a bidding pool in the following way.

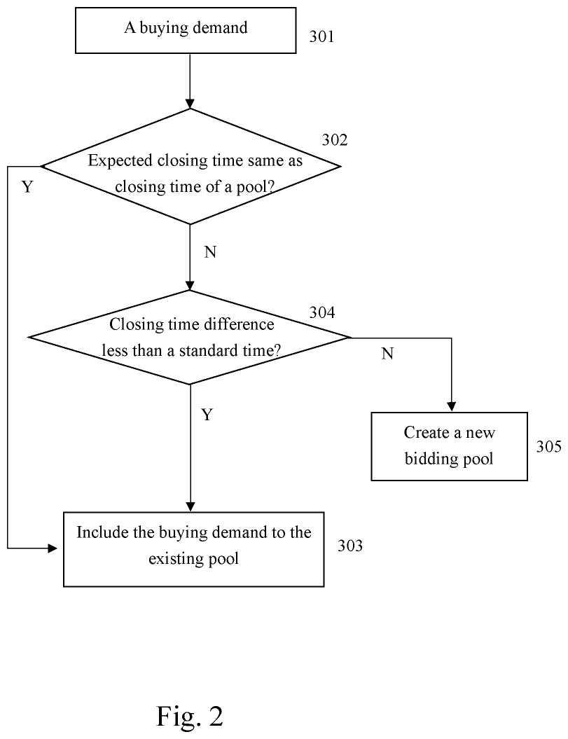

FIG. 2 shows a flow chart of a method for forming a bidding pool applicable in the system for management of online auction of the present invention. As shown in the figure, in this preferred embodiment of the present invention, at step 301 the auction management device 500 receives a buying demand for a particular product/service. At 302, the auction management device 500 determines whether there is already a bidding pool pertaining to the same item in the bidding transaction database, with the same closing time of the buying demand. If the result of determination in step 302 is yes, then the auction management device 500 adds the buying demand to the bidding pool in step 303 and updates the descriptive information of the bidding pool. Specifically, the quantity of the buying demand is added to the demand quantity of the bidding offers. On the contrary, if the result of determination in step 302 is negative, then the auction management device 500 further determines at 304 whether there is already a bidding transaction of the same product in the bidding transaction database 140, with its closing time having a time difference of less than a standard time gap with the expected bidding closing time of the received buying demand

In most embodiments of the present invention, the standard time gap is the shortest time inteval used to separate two consecutive bidding pools for the same product/service. There is no limit to the length of the standard time gap, and it can be determined by the system operator according to the nature, price, market demand, and other factors of the products/services. The time difference should not be so long that competition does not make any sense in between multiple consecutive bidding pools. Nor can it be too short, so as to cool down the buyer's willingness to “hop” to another bidding pool. In an ideal case, there will be multiple bidding pools in progress for the same product/service. That is to say, their closing time has not yet been reached, therefore buyers are allowed to place their buying demands in one of them at any time, and sellers can place their bidding offer in one of the bidding pools at any time. The interval between multiple bidding pools is preferably the “standard time gap” or an integral multiple thereof. However, in other preferred embodiments, the interval between the multiple bidding pools only needs to be equal to or longer than the “standard time gap.”

If the judgment result in step 304 is yes, it means that the desired closing time of the buying demand is not suitable for creating a new bidding pool. The reason is that a closing time too close to a preceding or following bidding pool is not suitable for utilizing the competition among the bidding pools. In this case, there may be a couple of methods for the auction management device 500 to adjust the expected closing time.

One possible method is to change the expected closing time to the closing time of the nearest bidding pool, and add the quantity corresponding to the buying demand to the demand quantity of the nearest bidding pool. Another possible method is to change (usually postpone) the expected closing time of the received buying demand so that the resulted closing time differs from its preceding bidding pool for one or multiple standard time gap. Yet another possible method is to display a warning message to the buyer who places the buying demand, explaining that the expected closing time is unacceptable, and propose a time or ask the buyer to input a time that is within the limit set by the system. Thereafter, the buying demand is established as a bidding pool, and the resulted time is set as the closing time of the bidding pool. Other methods to adjust and set the closing time can be determined by those skilled in the art according to their needs.

In this embodiment, if the judgment result in step 304 is yes, then the auction management device 500 adds the buying demand to the corresponding bidding pool at 304 and updates the bidding offer information. If there are two bidding pools, usually a preceding one and a following one, with a time difference shorter than the standard time gap, then add this buying demand to the bidding pool with the shorter or longer time difference according to needs or according to settings. On the contrary, if the judgment result in step 304 is negative, then the auction management device 500 creates a new bidding pool in the bidding transaction database 140 at 305, and imports the buying demand into the auction information of the bidding pool, and sets the closing time to be a time after the closing time of the preceding bidding offer, with a time difference of one or a multiple of the standard time gap. As mentioned above, there are many ways to determine the closing time of the newly-created bidding pool, and it is not limited thereto these examples. In this way, the grouping of bidding pool is achieved.

Another technical feature of the group buying and auction system of the present invention is the competition mechanism among bidding pools. In a preferred embodiment of the present invention, the auction management device 500 is also configured to allow participating buyers of a selected number of bidding pools to withdraw their buying demands within a first predetermined time before the closing time of a closing bidding pool, if the buyer places the same buying demand in the closing bidding pool.

As mentioned above, the bidding mechanism of the present invention is similar to that of so-called “group buying” or “online group buying.” In the group buying system, buyers who have placed a buying demand cannot withdraw the buying demand. This is because the quantity of products/services demanded by a bidding pool is a prerequisite for sellers to bid with the most favorable conditions. The demand quantity of the buying group affects the bidding price of the seller. If buyers are allowed to back out, the quantity demanded may reduce to even lower than a quantity, based on which the winning/active sellers expected to sell at the time of bidding. When this happens, the seller would cancel the offer, so that no contract cannot be concluded. Therefore, allowing buyers to withdraw from group buying is not preferred in the group buying system.

In the preferred embodiments of the present invention, however, the auction transaction manager 500 is configured to allow buyers who have participated in selected other bidding pools, that is, buyers who have placed their buying demands in the selected pools, to participate in a bidding pool that is approaching its closing time, while at the same time withdrawing from the bidding pools they currently participate.

In terms of specific implementation, a possible way is: within a first predetermined time before the closing time of a bidding pool (the “closing bidding pool”), to allow the buyers who have placed their buying demand in another bidding pool with a closing time difference shorter than a second predetermined time to participate in the closing bidding pool and, at the same time, to withdraw their buying demand from the other bidding pool.

Another possible way is to so configure the auction management device 500, so that buyers of a predetermined number of bidding pools whose closing time is later than the closing time of a closing bidding pool for a predetermined time are allowed to withdraw their buying demands and join the closing bidding pool, within a first predetermined time before the closing time of the closing bidding pool.

Other methods for selecting a bidding pool that can allow its buying demand to be withdrawn, when the related buyer places the same buying demand in another bidding pool for the same product can all be applied to the present invention. However, regardless of the selection method, when a buyer withdraws from one bidding pool, the auction management device 500 will add the withdrawn buying demand to the closing bidding pool. The predetermined bidding pools may be a pool with the earliest closing time, or a bidding pool selected by the buyer.

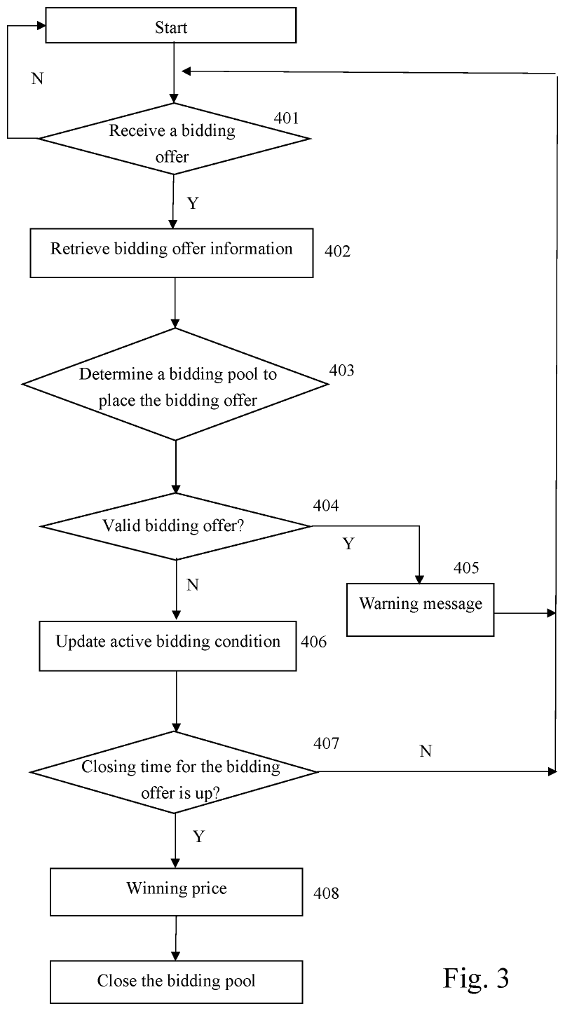

FIG. 3 shows a flowchart of the method for management of online auction applicable in the present invention. As shown in the figure, in terms of bidding, it is the same as the conventional bidding transaction systems. After a bidding pool is formed, the the auction management device 500 of the present invention determines in step 401 that the bidding transaction database 140 has received a bidding offer. The auction management device 500 retrieves the related product information and the expected closing time information contained in the bidding offer in step 402, and determines in step 403 which bidding pool the bidding offer is placed to. The auction management device 500 then compares the bidding conditions contained in the bidding offer at 404 with the bidding conditions of a currently active bidding offer of the bidding pool and determines which of them are favorable. In most embodiments of the present invention, the bidding condition is the price, and a lower price is a favorable condition.

If the result of judgment in step 404 is the currently active bidding offer, then in step 405 it is judged that the received bidding offer is invalid. Step returns to 401. On the contrary, at 406, the newly received bidding offer is labeled as valid and active, the seller information and the bidding condition information are updated, so that the price condition of the newly received bidding offer is set as the currently effective price. The auction management device 500 also judges in step 407 whether the closing time for the bidding offer is up. If yes, at 408, the bidding conditions valid at the closing time of the bidding pool are used as the concluded conditions, whereby the bidding is closed. Typically, this winning bid is the bidding offer with the lowest price. If the judgment result of step 407 is no, the step returns to step 401, to determine whether a new bidding offer is received.

As mentioned above, in a preferred embodiment of the present invention, the auction web page can display descriptive information of multiple bidding pools which closing time is not yet reached. The descriptive information of the multiple bidding pools is preferably arranged in sequence according to the closing time. The auction webpage may additionally display descriptive information of multiple bidding pools that have passed the closing time. Here, the descriptive information usually includes the following fields: identification of product/service, closing time, demand quantity, and currently valid bidding conditions. It may also include information regarding standard difference in bidding conditions, such as standard price. In addition, the bidding condition is usually the unit price of products/services. Therefore, the most favorable bidding condition is usually the lowest selling price. The bidding conditions may also include the unit price of the product/service and the prerequisites for the unit price to be valid; the prerequisites comprise the minimum buying quantity of the product/service.

Under the invented mechanism, buyers and sellers can view the ongoing and closed bidding pools from the auction webpage, and search for interested products/services.

Buyers who are interested in purchasing a product/service can select desired products from the ongoing bidding pools, and select the most-favorable bidding pool to join. To enable this, when placing a buying demand in the auction webpage, the buyer is required to describe a demand quantity.

If there is no suitable bidding pool to join, the buyer can freely create a new bidding pool. The way is to place a buying demand and include an expected closing time. In a preferred embodiment of the present invention, a buyer who creates a new bidding pool can also provide a maximum price limit to limit the price of the seller's bid.

The buying demand is verified as valid by the demand and bid validator 510, if, for example, the buyer is a qualified buyer recorded in the buyer database 130, the product is a product/service available in the product database 110, and the price or other bidding conditions meet the applicable requirements.

Interested sellers can choose to bid in one of the ongoing bidding pools. The usual approach is to offer a more favorable price. The bidding offer is usually made by the remote client computer 300 to the auction webpage, including a price and other bidding conditions, as well as necessary preconditions, including the minimum buying quantity of the product/service. If the seller's bidding offer is placed to a bidding pool that has an active bidding offer by another seller, the bidding conditions must be more favorable than the currently effective (most favorable) bidding offer, made by the same seller or another seller. For example, the price must be lower than the currently active bidding offer price.

The bidding offer is verified as valid by the demand and bid validator 510, if, for example, the seller is a qualified seller recorded in the seller database 120, the closing time of the bidding pool has not yet expired, and the price or other bidding conditions meet the applicable regulations, for example, the price is lower than the currently active bid.

When the quantity of buying demands of a bidding pool increases, interested sellers can observe this on the webpage and decides to submit bids with more favorable bidding conditions. For example, offering a lower selling price.

At the first predetermined time, such as 10 minutes or 15 minutes, before the closing time of the bidding pool, the auction management device 500 displays a message that “bidding is about to end” on the auction webpage. In a preferred embodiment of the present invention, the auction management device 500 can also be configured to announce the “bidding is about to end” information to a predetermined number of bidding pools whose closing time is approaching. For example, announce to 3 bidding pools which closing time is within 60 minutes from the closing time of the closing bidding pool.

The first predetermined time and the number of bidding pool can be manually set by the system operator according to requirements, as mentioned above.

At the same time, the auction management device 500 also allows buyers who have participated in the predetermined number of bidding pool, that is, buyers who have placed their buying demand in the predetermined number of bidding pool, to withdraw their buying demand from the participating bidding pools and participate in this closing bidding pool. That is, the withdrawn buying demand is included into the closing bidding pool.

Due to the addition of buying demands from other bidding pools into the closing bidding pool, the demand quantity increases sharply. After interested buyers find out, in order to win the transaction, they may decide to place their bids with more favorable conditions to the closing pool.

During this period, more buyers would withdraw from other bidding pools and join this closing pool, after discovering the more favorable conditions. Prompting more sellers to offer more favorable bidding conditions, until the closing time of the bidding pool.

The system and method for management of online auction can bring benefits to both the buyers and the sellers. Buyers can purchase products and services on the most favorable conditions and sellers get higher profits, due to the increase in sales volume.

In most embodiments of the present invention, the auction management device 500 can also be configured to: when the demand quantity of a bidding pool is less than the demand quantity at the time the currently active bidding offer is placed, cancel the active bidding offer at that time. The auction management device 500 can also be further configured to: in the above situation, replace the currently active bid offer with the second favorable bidding offer, i.e., the second lowest selling price, if all prerequisites meet. In such an embodiment, the auction management device 500 may also be configured to ask the seller of the currently active bidding offer whether to cancel, before canceling it. If the seller declines, the bidding offer will not be cancelled. The auction management device 500 can also be configured to obtain a minimum demand quantity requirement of a bidding offer, when the bidding offer is received, and, when the demand quantity of the bidding pool has reduced to less than the required minimum quantity, automatically cancel this bidding offer, or cancel it and replace it with a next lowest price.

In other embodiments of the present invention, within the first predetermined time period, or at any time, potential sellers may also be allowed to place conditional bids, wherein the condition may comprise a minimum buying quantity. This and the above embodiments are all applicable embodiments in compliance with the features of the present invention. Other applications can be formulated and implemented by a skilled person in the industry according to needs, as long as the impact of buyers withdrawing from a bidding pool can be moderated.

The system for management of online auction of the present invention may also comprise a fee-collection device, which can be configured to notify the winning price and quantity via the notification manager 520 to those participating in the bidding pool, after a bidding pool is closed, for the buyers and the winning seller to complete the transaction.

When the present invention is used, the auction webpage is published via the Internet, attracting buyers to place buying demands for a variety of product/service on the network, and to form a bidding pool. Sellers compete by their bidding price. When the bidding conditions of one bidding pool become more favorable than those of other groups, buyers from other bidding pool join in the bidding pool, hoping to enjoy the more favorable conditions. The result attracts more sellers to bid. Competition among bidding pools is thus generated.

The present invention proposes a new mechanism of group buying, in which not only sellers compete with more favorable bidding conditions, but the bidding pools also compete among each other, whereby buyers and sellers benefit from the invented system. An unprecedented innovative group buying and auction system is provided by this invention.

What is claimed is:

1. A system for management of online auction, which transmits and processes auction information in a computer network capable of communicating between a host computer and a plurality of remote client computers; the system comprising:
a host computer having data processing and communication capabilities, connected to the computer network, and configured to transmit data to and receive data from the remote client computers via the computer network;
a product database in communication with the host computer, configured to store product information, wherein the product information describes identifications of product/service available for bidding transaction, and an index to a plurality of qualitied sellers corresponding to each product/service;
a seller database in communication with the host computer, configured to store seller information relating to a plurality of qualified sellers; wherein the seller information further comprises descriptions relating to payment instruments usable by a corresponding seller and products/services relating to a corresponding seller;
a buyer database in communication with the host computer, configured to store buyer information of a plurality of qualified buyers, wherein the buyer information further comprises descriptions relating to a credit limit of a corresponding buyer and payment instruments usable by a corresponding buyer;
an auction database in communication with the host computer, configured to store buying demand information and bidding offer information, wherein the buying demand information describes buying demands of products/services received from one of the remote client computers, and comprises product information, demanding quantity and expected closing time of a corresponding product/service; and wherein the bidding offer information describes bidding offers of products/services received from one of the remote client computers, and comprises product information, offering price and expected closing time of a corresponding product/service; and
an auction management device, implemented in the server computer and in communication with the product database, the seller database, the buyer database and the auction database, configured to receive and to process buying demand information and bidding offer information of products/services received by the auction database, and to determine whether a contract consisted of a buying demand and a bidding offer is concluded;
wherein the auction management device is configured to manage multiple bidding pools for product/service, wherein one or more buying demand for a same product/service with the same expected closing time forms a bidding pool;
and wherein the auction management device is configured to allow a buyer having placed a buying demand in one of selected bidding pools to withdraw the buying demand from the participating bidding pool within a first predetermined time before a closing time of another bidding pool.

2. The system for management of online auction according to claim 1, wherein the auction management device provides an auction webpage for one of the remote client computers to access through the computer network; wherein the auction webpage displays at least descriptive information of at least one bidding pool which closing time is not reached.

3. The system for management of online auction according to claim 1, wherein the auction management device is configured to set a closing time for a product/service in the product database, and to cause a buying demand of product/service to include only one expected closing time, and to include all buying demands for a same product/service with a same expected closing time into one bidding pool.

4. The system for management of online auction according to claim 3, wherein a time gap between closing times of two bidding pools of a same product/service is an integral multiple of a standard time gap.

5. The system for management of online auction according to claim 1, wherein in the product database, the product information of the products/services available for bidding transactions comprises a product classification code, whereby a plurality of products/services corresponding to a same classification code is classified as a same product or alternative products.

6. The system for management of online auction according to claim 1, wherein the auction management device is configured to allow a buying demand in one of selected bidding pools to withdraw from the participating bidding pool within the first predetermined time before the closing time of the other bidding pool, if the time difference of the closing times of the selected bidding pools and the other bidding pool is less than a second predetermined time.

7. The system for management of online auction according to claim 1, wherein the auction management device is configured to allow a buying demand in one of a predetermined number of bidding pools, which closing time is after a closing time of another bidding pool, to withdraw from the participating bidding pool, if a corresponding buying demand by the same buyer is placed in the other bidding pool.

8. The system for management of online auction according to claim 1, wherein the auction management device is configured to place a buying demand of a buyer in a predetermined bidding pool, when the buyer withdraws a buying demand from a participating bidding pool.

9. The system for management of online auction according to claim 8, wherein the predetermined bidding pool is a bidding pool with an earliest available closing time or a bidding pool selected by the buyer.

10. The system for management of online auction according to claim 1, wherein the auction management device is configured to withdraw a lowest bidding offer of a bidding pool, when a quantity of the buying demands of the bidding pool is less than a quantity of buying demands at the time the lowest bidding offer is placed, and replace the lowest bidding offer with a second lowest available bidding offer.

11. The system for management of online auction according to claim 10, wherein the bidding managing tool is further configured to, before withdrawing the lowest bidding offer, obtain a determination of whether to withdraw from the seller with the lowest bidding offer, and to stop withdrawing the lowest bidding offer, if the determination is not to.

12. The system for management of online auction according to claim 10, wherein the auction management device is further configured to, when accepting a bidding offer, obtain a minimum quantity requirement to the bidding offer and to withdraw the bidding offer, when the buying quantity of the corresponding buying demands is less than the minimum quantity, or, in addition, to replace the bidding offer with a second lowest available bidding offer.

13. The system for management of online auction according to claim 1, wherein the auction management device is further configured to close a bidding pool at the closing time of the bidding pool and use the lowest bidding offer at the closing time as a concluded price of the bidding pool.

14. The system for management of online auction according to claim 1, wherein the auction management device is configured to:
when receiving a buying demand for a product/service, determine whether a bidding pool for the same product/service with a closing time identical to an expected closing time of the buying demand is included in the auction database;
if yes, include the buying demand to the bidding pool and update a bidding offer information of the bidding pool;
otherwise, determine whether a bidding pool for the same product/service with a closing time different from the expected closing time of the buying demand by a time shorter than the standard time gap is included in the auction database;
if yes, include the buying demand to the bidding pool and update a bidding offer information of the bidding pool;
otherwise, establish a new bidding pool in the auction database and include the buying demand to the newly established bidding pool, followed by setting a closing time of the newly established bidding pool as a time different from a closing time of an immediately preceding bidding pool by an integral multiple of the standard time gap.

15. The system for management of online auction according to claim 1, further comprising a demand and bid validator and an notification manager; wherein, the demand and bid validator can be implemented in the host computer for verifying information from the client computer to determine whether a buying demand and/or a bidding offer is valid; and
Wherein the notification manager is in communication with the host computer, the auction management device and the auction database, for providing electronic notification to the remote client computer via the host computer.

16. The system for management of online auction according to claim 1, further comprising a fee collecting device, configured to notify buyers and corresponding winning sellers of the winning price and quantity after a bidding pool is closed, so as to complete the transaction.

17. The system for management of online auction according to claim 1, wherein said bidding condition is unit price of a related product/service; the most-favorable bidding condition is a lowest bidding price.
